(19) United States
(12) Patent Application Publication
(10) Pub. No.: US 2010/0064214 A1
(43) Pub. Date: Mar. 11, 2010

(54) ELECTRONIC SYSTEM AND INTERACTIVE INPUTTING METHOD THEREOF

(75) Inventors: Kuan-Lin Wu, Tu-Cheng (TW); Wei-Yuan Chen, Tu-Cheng (TW); Cho-Hao Wang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/331,409

(22) Filed: Dec. 9, 2008

(30) Foreign Application Priority Data
Sep. 5, 2008 (CN) 200810304397.8

(51) Int. Cl. G06F 3/041; G06F 3/048

(52) U.S. Cl. 715/702; 715/825; 715/819

(57) ABSTRACT

An interactive input method of an electronic system displays at least two images selected from different image groups on an image input field and receives one of the at least two images, at least one next input field or a confirm input field. Each of the at least two images of the image input field is stored in turn. A next image input field and at least two images of the next image input field selected from the at least two different image groups are generated by selecting the at least one next input field. The next image input field stops generating by selecting the confirm input field.

### BACKGROUND

1. Technical Field

The invention relates to an electronic system and input method thereof and, more particularly, to an electronic system and interactive input method thereof.

2. Description of Related Art

Before a user uses a network service, personal information needs to be inputted such as an identification and a password to confirm the user's identity. Malicious programs can spread as the user downloads data or browses web pages. Therefore, when the user enters personal information, the personal information of the user is decoded and stolen by the malicious programs.

A typical preventing method is to design an interface to receive the personal information without using the keyboard, and each time the user uses the interface, the input motions of the user are not different. For example, in a display interface of a system, the input values such as numbers or letters are designed to be images displayed for the user to select by some random arrangement method.

However, when the interface has a large number of these images, the random arrangement positions of the images are different every time causing difficulty for the user to select the images real time.

What is needed, therefore, is an electronic system and interactive input method thereof which can prevent to be stole by the malicious programs and decrease the difficulty of the selection.

### BRIEF DESCRIPTION OF THE DRAWINGS

FIG. 1 is a block diagram of hardware structure of one embodiment of an electronic system.

FIG. 2 is a schematic view of the display input frame of the display unit of the electronic system of FIG. 1.

FIG. 3 is a schematic view of the display input frame of the display unit of the electronic system of FIG. 1.

FIG. 4 is a schematic view of the display input frame of the display unit of the electronic system of FIG. 1.

FIG. 5 is a schematic view of the display input frame of the display unit of the electronic system of FIG. 1.

FIG. 6 is a schematic view of the display input frame of the display unit of the electronic system of FIG. 1.

FIG. 7 is a flowchart of one embodiment of an interactive input method for an electronic system.

### DETAIL DESCRIPTION

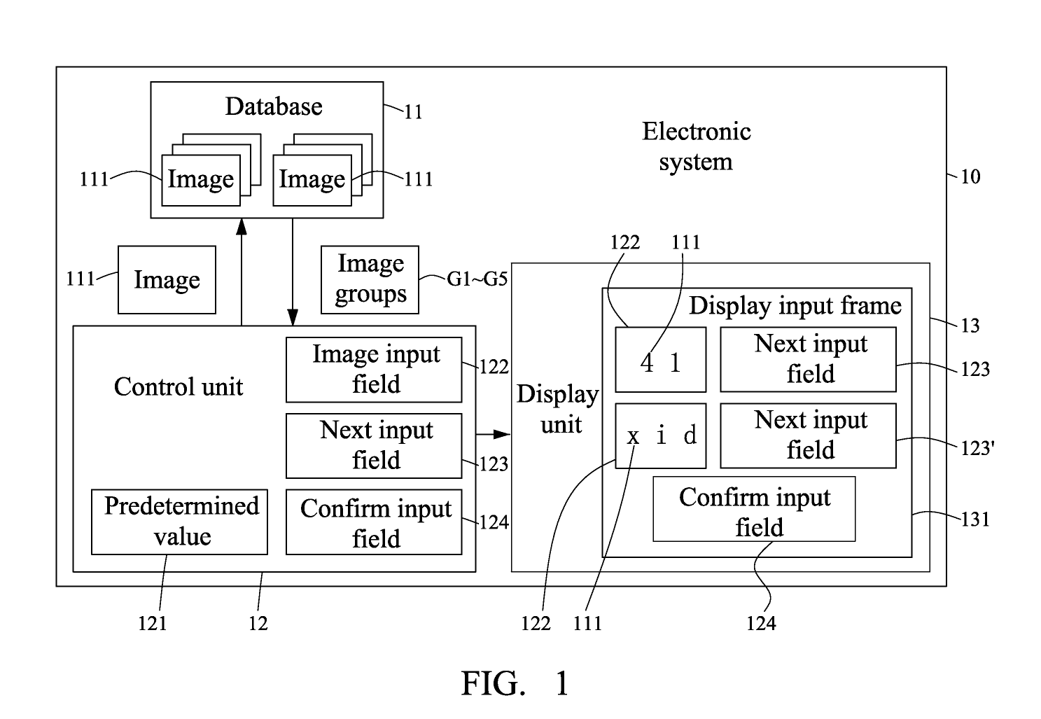

Referring to FIG. 1, an electronic system 10 includes a database 11, a control unit 12, and a display unit 13.

The database 11 stores a plurality of images 111 each corresponding to a word, a number, a pattern, or a letter. For example, the database 11 stores the images 111 of ten ciphers from “0” to “9” and the images 111 of twenty six letters from “a” to “z”.

In one embodiment, the control unit 12 has a plurality of predetermined values 121, at least one image input field 122, at least one next input field 123, and a confirm input field 124. Each of the image input field 122 displays at least two of the images 111. The control unit 12 divides the images 111 into a plurality of image groups G according to the predetermined value 121, and stores the images 111 of the image groups G in the database 11 in turn. The next input field 123 changes the next image input field 122. The control unit 12 receives an input instruction, for example, a first input instruction D1, a second input instruction D2, or a third input instruction D3 to store, transmit, or stop the images 111 to the image input field 122. For example, the control unit 12 has the predetermined values 121 inputted and set from outside of the electronic system 10. The predetermined values 121 correspond to the different type of the images 111 to be divided into random groups. Therefore, numbers of the image groups G are different. For example, the image input field 122, the next input field 123, and the confirm input field 124 are keys or buttons.

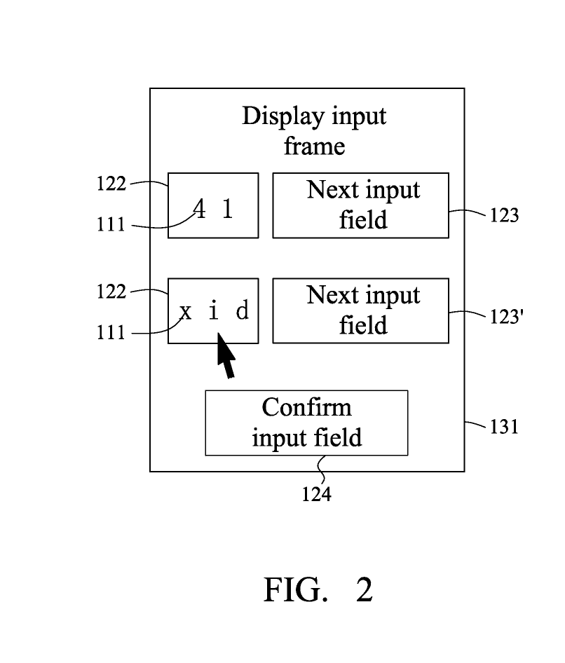

Referring also to FIG. 1 and FIG. 2, the display unit 13 has a display input frame 131 to display each of the next input fields 123, the confirm input field 124, and each of the image input fields 122 where the images 111 are displayed. For example, the display input frame 131 can display two of the image input fields 122. The display unit 13 may be a touch control display.

An exemplary interactive input operation of the electronic system 10 in FIG. 1 follows.

The database 11 of the electronic system 10 stores the images 111 of ten ciphers from “0” to “9” and the images 111 of twenty six English letters from “a” to “z.” The control unit 12 has two of the predetermined values 121 which are “2” and “3.” The control unit 12 divides the images 111 of ten ciphers into two of the image groups G1, G2 as “6, 9, 3, 4, 0” and “2, 8, 5, 1, 7” according to the predetermined value 121 which is “2,” and the images 111 of the letters into three of the image groups G3, G4, G5 as “y, b, n, x, e, r, h, t, l,” “s, g, c, i, u, m, p, w.” and “a, k, o, d, q, f, v, j, z” according to the predetermined value 121 which is “3.” The control unit selects one of the images of each the image groups G1, G2 to combine to form (6, 2), (9, 8), (3, 5), (4, 1), (0, 7), and the control unit selects one of the images of each of the image groups G3, G4, G5 to combine to form (y, s, a), (b, g, k), (n, c, o), (x, i, d), (e, u, q), (r, m, f), (h, p, v), (t, w, j), (l, z), and stores in the database 11.

Referring also to FIG. 1 and FIG. 2, when the user logins to the electronic system 10, the user needs to enter his personal information such as a password, for example, im885. At this time, the display input frame 131 of the display unit 13 displays two of the image input fields 122, the images 111 which are (4, 1) and (x, i, d), and two of the next input fields 123, 123′ at random.

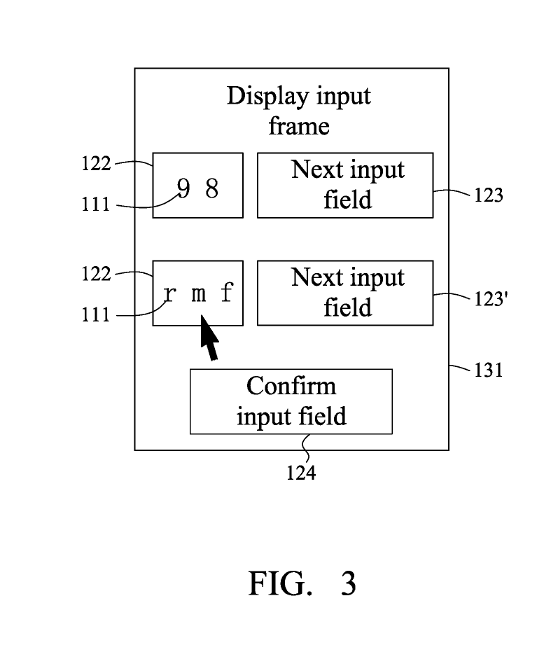

Referring also to FIG. 2 and FIG. 3, the user selects the letter “i” of the image of the image field 122, and the control unit 12 stores the letter “i” of the image 111 according to the first input instruction D1. The user selects the next input fields 123, 123′ again, and the control unit 12 transmits another two of the image input fields 122 and the images which are (9, 8) and (r, m, f) according to the second input instruction D2 to the display input frame 131 of the display unit 13, as shown in FIG. 3, and the letter “m” of the image 111 are stored in the control unit 12.

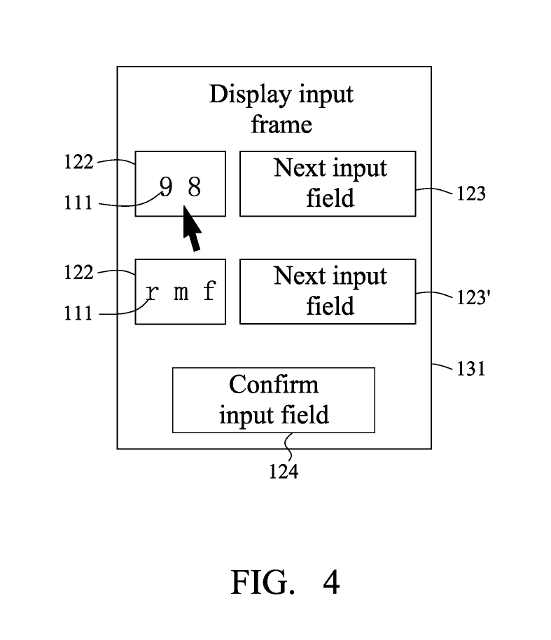

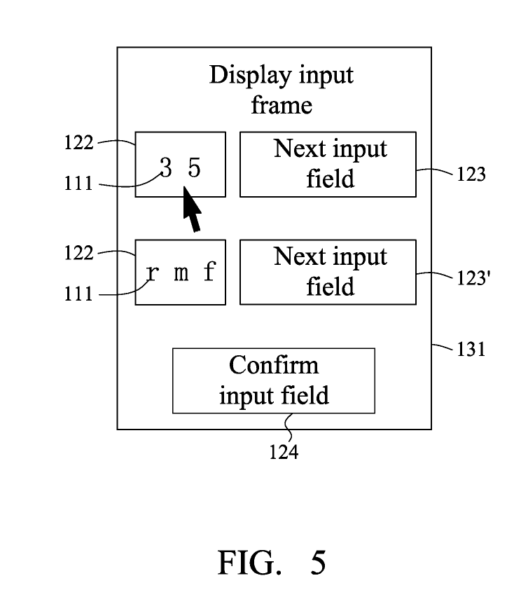

Referring to FIG. 4, the user selects the number “8” of the image 111 of the image input field 122 twice to store in the database 11, and selects the next input field 123 to display the next image input field 122 and the next image 111 which is (3, 5) to replace the preceding image input field 122. The user then selects the number “5” of the image 111 to store in the database 11, as shown in FIG. 5.

If the image 111 is not what the user wanted, the user selects each the next input field 123, 123′ until the user finds the numbers of the image 111 or the letters of the image 111 desired.

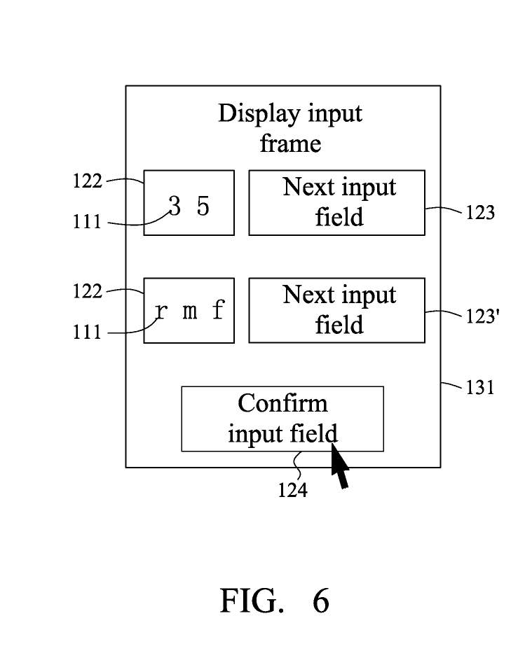

Referring to FIG. 6, when the user has finished inputting the personal information, the user selects the confirm input field 124, so that the control unit 12 stops transmitting the next image input field 122 and the next images 111 according to the third input instruction D3.

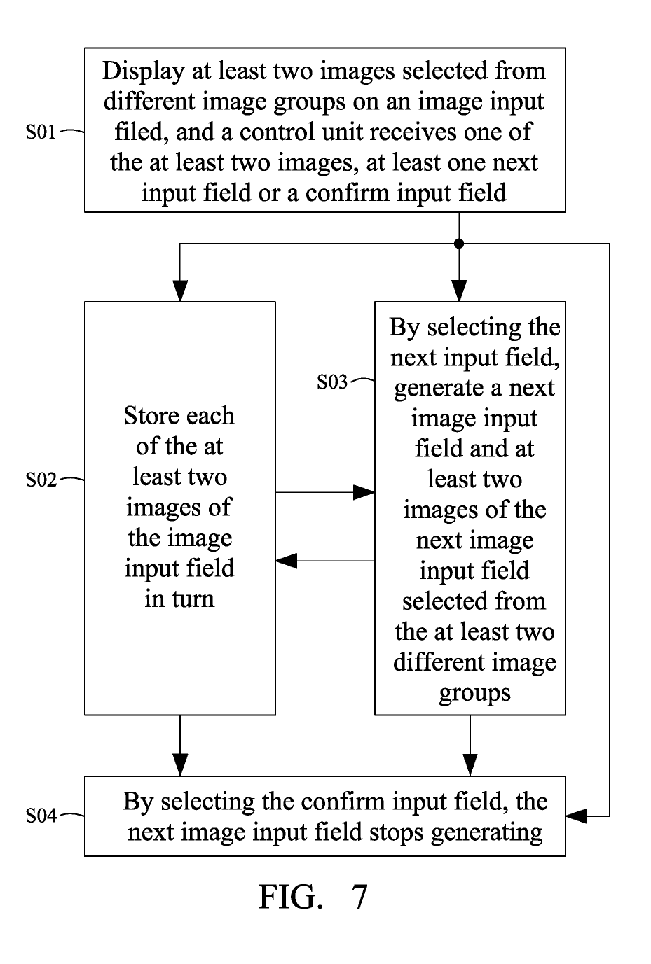

Referring to FIG. 7, one embodiment of an interactive input method of the electronic system 10 is shown. Depending on the embodiment, certain of the steps described below may be removed, others may be added, and the sequence of steps may be altered.

In step S01, an image input filed displays at least two images selected from different image groups, and one of the at least two images, at least one next input field or a confirm input field is received. The electronic system 10 executes steps S02, S03, or S04 according to different demands.

In step S02, each of the at least two images of the image input field is stored in turn.

In step S03, a next image input field and at least two images of the next image input field selected from the at least two different image groups are generated by selecting the next input field. The electronic system executes the step S02 or S04 accordingly.

In step S04, by selecting the confirm input field, the next image input field stops generating.

In this embodiment, the electronic system 10 and the interactive input method thereof divide the images 111 into the image groups G at random and generate the next image input field 122 according to the next input field 123 to provide to be selected. In this way, along with the images 111 are divided into a plurality of groups for decreasing the difficultly of the selection, and to prevent the information of the electronic system 10 from decoding by the side record of malicious codes.

It is to be understood that the disclosure is intended to illustrate rather than limit the invention. Variations may be made to the embodiment of the disclosure without departing from the spirit of the invention as claimed.

What is claimed is:

1. An interactive input method of an electronic system, comprising:
displaying at least two images selected from at least two different image groups on an image input field, receiving one of the at least two images, at least one next input field or a confirm input field;
storing each of the at least two images of the image input field in turn;
generating a next image input field and at least two images of the next image input field selected from the at least two different image groups by selecting the at least one next input field; and
stopping generating the next image input field by selecting the confirm input field.

2. The method as claimed in claim 1, wherein the image is a word, a number, a pattern or a letter.

3. The method as claimed in claim 1, further comprising the following steps after the step of storing each of the at least two images of the image input field in turn:
executing the step of generating the next image input field and at least two images of the next image input field selected from the different image groups; and
executing the step of stopping generating the next image input field.

4. The method as claimed in claim 1, further comprising the follow steps after the step of generating the next image input field:
executing the step of storing each of the at least two images of the image input field in turn;
executing the step of generating the next image input field and at least two images of the next image input field selected from the at least two different image groups; and
executing the step of stopping generating the next image input field.

5. The method as claimed in claim 1, wherein the image groups has a plurality of words, a plurality of numbers, a plurality of patterns or a plurality of letters.

6. The method as claimed in claim 1, wherein the number of the image groups, the number of the images of the image input fields correspond to a predetermined value.

7. An electronic system, comprising:
a database storing a plurality of images;
a control unit having at least one image input field, a next input field and a confirm input field, the control unit dividing the images into at least two different image groups according to a predetermined value to store to the database in turn, the control unit receiving and according to an input instruction to store, transmit or stop the images to the image input field; and
a display unit having a display input frame to display the next input field, the confirm input field, the image input field and the images.

8. The electronic system as claimed in claim 7, wherein the predetermined value is at least one numeral.

9. The electronic system as claimed in claim 7, wherein the number of the image groups, the number of the images of the image input fields and a predetermined value correspond to each other.

10. The electronic system as claimed in claim 7, wherein the image is a word, a number, a pattern or a letter.

11. The electronic system as claimed in claim 7, wherein the at least two image groups has a plurality of words, a plurality of numbers, a plurality of patterns or a plurality of letters.

12. The electronic system as claimed in claim 7, wherein the display unit is a touch control display.
